(19) United States
(12) Patent Application Publication
(10) Pub. No.: US 2015/0213653 A1
(43) Pub. Date: Jul. 30, 2015

(54) MOTION CAPTURE SYSTEM

(71) Applicant: Ali Kord, Los Angeles, CA (US)

(72) Inventor: Ali Kord, Los Angeles, CA (US)

(21) Appl. No.: 14/523,714

(22) Filed: Oct. 24, 2014

Related U.S. Application Data
(60) Provisional application No. 61/895,052, filed on Oct. 24, 2013.

(51) Int. Cl. G06T 19/20; G06F 3/01; G06T 7/00

(52) U.S. Cl. CPC G06T 19/20; G06T 7/0065; G06T 7/0071; G06T 7/0077; G06F 3/011; G06T 2219/2008; G06T 2207/30196; G06T 2207/30204; G06T 2200/04; G06T 2207/10021

(57) ABSTRACT

Embodiments form a calibrated biomechanical skeleton from images including a scale frame and a motion capture subject. Links and joints for the biomechanical skeleton are overlaid on a silhouette created for each image in a sequence of captured images. A true length for each link and an accurate position for each biomechanical reference location are determined from a comparison of true dimensions of the scale frame to measurements taken from recorded camera images. The motion capture subject may perform a sequence of calibration motions to allow joint locations in the biomechanical skeleton to be positioned accurately over corresponding skeletal joints in the motion capture subject. Accurate link lengths for the biomechanical skeleton may be determined by compensating measured link lengths in images with true dimensions of struts and calibration markers included in the scale frame.

### FIELD OF THE INVENTION

Embodiments are generally related to systems for creating a graphical model of a motion capture subject from information collected from camera images and optionally from position sensors, and more specifically to a method for accurately calibrating motion capture images with a scale frame.

### BACKGROUND

An articulated, movable graphical model of a person may be created by measuring the movements of a human body performing motions such as walking, flexing arms or legs, rotating the head, and so on. The graphical model may take the form of a biomechanical skeleton. The positions of a person's limbs and joints may be recorded and mapped onto the biomechanical skeleton to simulate the motions of a human being or other motion capture subject. An image of a character may be superimposed over the biomechanical skeleton in a scene in a video, computer game, or motion picture. A biomechanical skeleton may be articulated differently than a human skeleton, possibly by modeling fewer joints or by aggregating some complicated structures, such as a hand or foot, into a simpler model. For example, a foot in a biomechanical skeleton may lack individually movable toes.

Motion capture systems have used several different approaches for recording and measuring a subject's motions and determining parameters for a model such as a biomechanical skeleton. Some motion capture systems use triangulation to detect limb and joint positions in a camera image, for example by recording a scene with more than one camera simultaneously and comparing images captured by each camera with known camera positions, camera angles, and other factors to compute skeleton parameters such as limb length, limb angle, joint position, head position, head tilt and rotation angles, waist and torso positions and angles, and so on. Motion capture systems using triangulation may require space for mounting more than one camera outside the field of view representing a scene to be captured. Such systems may be very expensive to set up, difficult to calibrate, complicated to operate, and may require sophisticated post-acquisition data analysis to process images from different cameras, each with a different view of a scene and motion capture subject.

Some motion capture systems place one or more capture targets on a motion capture subject to provide reference positions or reference points for triangulation. The capture targets, for example reflective patches, reflective hemispheres, paint dots, and the like, may require intense illumination, illumination with infrared or other frequencies not visible to the human eye, cameras sensitive to infrared light, or other specialized photography equipment to be effective. Capture targets may interfere with the appearance or responses of the motion capture subject. A capture target may be blocked from the field of view of a camera when a motion capture subject moves about, possibly impairing accurate motion capture. For example, one or more capture targets may be occluded by another target, by a limb or other part of a motion capture subject's body, or by an object near the motion capture subject. Capture targets on the front of a person's torso may be obscured from the camera's position when then person turns his back to a camera, preventing accurate motion capture. Target occlusion is a well-known problem in prior art systems and leads to the use of more cameras, longer post-processing, and possibly artistic limitations in the scenes which can be created. The greater the number of capture targets a motion capture system uses for forming a graphical model, the more likely the occurrence of target occlusion from one or more cameras. Motion capture systems using triangulation of capture targets have been too complicated to set up and operate, too expensive, and map a biomechanical skeleton or a character into a scene too slowly for mass-market applications such as computer games.

Other motion capture systems attach one or more position sensors to limbs, joints or other reference positions to be represented in a graphical model of a motion capture subject. For motion capture systems previously known in the art, each separately movable portion of an articulated model may use a separate position sensor to measure the movement and position of the corresponding part of the subject's body. Parts of the subject's body which are collectively represented by one sensor may be positioned inaccurately in the resulting graphical model. For example, placing one sensor on a subject's wrist may allow a model wrist to mimic the subject's motions, but the model's elbow may not move the same way as the subject's elbow unless another sensor is placed on the subject's elbow.

Some motion capture systems require a person to wear an articulated frame for measuring angles between parts of a limb, spine, torso, or other parts of a person's body. Examples of articulated frames and biomechanical skeletons are described in U.S. Pat. No. 5,826,578, although articulated frames and biomechanical skeletons may take other forms. Articulated frames may be useful for measuring relative limb angles but do not provide direct measurement of translational changes in limb position, that is, displacements with a component of motion parallel to one or more of the three conventional spatial axes in a motion capture coordinate system. The articulated frame may be susceptible to damage during vigorous activity, may interfere with a person's speed of motion or impair a full range of motion, and may have a visual appearance that detracts from a preferred aesthetic effect in a camera image.

A biomechanical skeleton may model a motion capture subject as a combination of rigid links joined to one another by rotatable joints. An image from a camera of a motion capture subject may be analyzed to map selected locations in the image to joints and links in the biomechanical skeleton. Images may be combined with data from inertial measurement sensors, accelerometers, or articulated frames to assign positions and lengths to links, positions and angles to joints, and positions and postures for a biomechanical skeleton. However, sensors used for measuring position data, direction of motion, or angles may be subject to measurement error and drift. Measurement errors may be cumulative, especially for repetitive motions such as walking, leading to cumulative errors in the location of a biomechanical skeleton relative to other objects or to an absolute position reference, and possibly leading to errors in relative positions or angles between parts of the skeleton. Cumulative errors may cause an abrupt, undesirable jump in the position of a biomechanical skeleton or of part of the skeleton such as a foot or hand. Or, cumulative errors may cause a biomechanical skeleton to be positioned incorrectly in a scene, for example with part of a character's foot below the surface of the floor or with a character's hand intersecting the volume occupied by another solid object in the scene. Cumulative errors may prevent a biomechanical skeleton from achieving a preferred posture or arrangement of limbs or may locate the skeleton incorrectly relative to other objects in a scene. For example, a motion capture subject may rise from a chair, walk around a table, and return to the chair, but a biomechanical skeleton executing the same sequence may end the series of motions by stopping in a seated position in empty space near the chair or with part of a leg from the skeleton occupying the same volume as a solid part of the chair.

Motion capture accuracy, for example accurate determination of link lengths and joint positions in a biomechanical skeleton, may be improved by determining a distance from the motion capture subject to the camera used for recording images of the motion capture subject. Some motion capture systems use a noncontact distance measuring instrument that measures the time of flight of a radio frequency pulse or acoustic pulse to determine a separation distance between the camera and a reference location on a motion capture subject. The distance between the motion capture subject and the camera may be referred to as the camera-subject distance or the object distance. The distance measuring system may measure an incorrect camera-subject distance when the reference location is blocked from the field of view of the measuring instrument. Systems using triangulation may report incorrect camera-subject distances when a capture target on a motion capture subject is not visible from the viewing angle of a motion capture camera. For example, a person may interpose a hand between a motion capture camera and a reference position on the person's body, preventing the camera from viewing the reference position and preventing accurate motion capture.

### SUMMARY

An example of an apparatus embodiment includes a scale frame having at least three struts and at least four calibration markers. One of each of the at least four calibration markers is attached to an end of each of the at least three struts and the at least three struts are joined at right angles to one another by one of the at least three calibration markers. The apparatus embodiment further includes a camera and a computer implemented in hardware. The computer is in data communication with the camera. The computer is adapted to receive an image from the camera, convert the image to a silhouette, and extract parameters for a biomechanical skeleton from the image. The apparatus embodiment optionally includes a motion capture sensor in data communication with the computer.

An example of a method embodiment includes positioning a camera facing a scale frame with an optical axis for a lens on the camera horizontal and directed at a front side of the scale frame; positioning a motion capture subject inside the scale frame; and recording at least two images, each image including the motion capture subject and the scale frame. The example of a method embodiment further includes converting a first image of the motion capture subject to a first silhouette image; converting a second image of the motion capture subject to a second silhouette image; assigning a first biomechanical reference location for a biomechanical skeleton from a comparison of the first silhouette image to the second silhouette image; and assigning a second biomechanical reference location for the biomechanical skeleton from a comparison of the silhouette image to the second silhouette image. The example of a method embodiment also includes connecting a link in the biomechanical skeleton between the first and second biomechanical reference locations; assigning the projected length of the link from the positions of the first and second biomechanical reference locations measured from the first and second images of the motion capture subject; measuring the projected length of a selected strut on the scale frame in the first and second images; determining a true length of the link from the projected length of the link and the projected length of the strut in the first image and the projected length of the strut in the second image; and assigning the true length of the link to the biomechanical skeleton.

### BRIEF DESCRIPTION OF THE DRAWINGS

FIG. 1 shows an example of an apparatus embodiment configured to determine parameters for a biomechanical skeleton, and further showing an example of a biomechanical skeleton overlaid on a motion capture subject.

FIG. 2 shows the example of a biomechanical skeleton from FIG. 1 with the knees flexed and with a change in camera-subject distance compared to FIG. 1.

FIG. 3 shows a pictorial view of an example of apparatus embodiment.

FIG. 4 is a pictorial view toward the front of a motion capture subject standing in an example of a scale frame, with the subject's right hand at the left side of the figure, an example of a biomechanical skeleton model overlaid on an image of the motion capture subject, and examples of motion capture sensors positioned on the motion capture subject.

FIG. 5 is a pictorial view of the motion capture subject and scale frame from the example of FIG. 4, with the scale frame positioned and oriented as in FIG. 4 and the person turned so that her right side faces the camera.

FIG. 6 is an example of a silhouette representing the posture and camera-subject distance from the example of FIG. 4, and further representing an alternative position of a limb for performing a calibration of the biomechanical skeleton superimposed over the silhouette.

FIG. 7 shows an example of a modification to the silhouette from the example of FIG. 6, corresponding to changes in the camera-subject separation distance and posture of the motion capture subject.

FIG. 8 illustrates an example of a position sensor suitable for use with an apparatus embodiment (PRIOR ART).

FIG. 9 illustrates an example of a motion capture sensor location relative to a biomechanical skeleton and a silhouette of a motion capture subject.

FIG. 10 is a block diagram of connections between motion capture sensors and a central processing unit (CPU) included in some embodiments.

### DESCRIPTION

An embodiment, also referred to herein as a motion capture system or mocap system, employs one camera to record a sequence of images of a motion capture subject, for example a person. Images from the sequence may be processed to produce a corresponding sequence of silhouettes of the motion capture subject. Each silhouette is processed to assign values to parameters for a graphical model capable of accurately emulating selected body positions, postures, and motions performed by the motion capture subject. The graphical model, also referred to as a biomechanical skeleton, is calibrated by an apparatus embodiment to accurately simulate motions that could be made by the motion capture subject. An accurate camera-subject distance for each silhouette may be determined from the calibrated biomechanical skeleton. Depth cues may be determined for different parts of a silhouette from the biomechanical skeleton. One or more motion capture sensors may optionally be included to improve positioning accuracy of the biomechanical skeleton or graphical model in a scene. The motion capture sensors may provide a real-time position estimate of the motion capture subject while the subject's movements are being captured.

An apparatus embodiment includes a scale frame having known linear dimensions for measuring the lengths of objects in or near the frame and for calibrating images from a camera and a computer system implemented as hardware to analyze images collected by the camera. By comparing known sizes of scale frame components to sizes of the same frame components measured in captured images, dimensions, angles, and positions of objects in the frame, adjacent the frame, or within a known distance of the frame in captured images may be determined accurately. Examples of parameters which may be determined accurately from an image of a motion capture subject include, but are not limited to, limb angles, limb length, joint position, limb and joint positions with respect to an absolute position reference, limb angles, and distances traversed by the motion capture subject or by parts of the subject's body. After calibration is performed, the frame may be removed from the scene and distances traversed by the motion capture subject, positions of the subject relative to other objects in a scene, and positions of limbs and other parts of the person's body may be determined with high accuracy.

Embodiments are capable of making a new, accurate measurement of camera-subject distance for each image of a motion capture subject in a sequence of camera images. A measured camera-subject distance may be compared to a calculated camera subject distance to detect and remove accumulated errors in the position or posture of a biomechanical skeleton, thereby improving motion capture accuracy compared to motion capture systems previously known in the alt.

Embodiments are well suited to real-time motion capture and display of mapped images. An embodiment is considered to be real time because capture, processing, and display steps can be performed on each frame in a sequence of image frames streamed at conventional video display rates in television images, computer games, and video recordings.

The model used in an embodiment, also referred to as an actor file, represents a person as an articulated biomechanical skeleton comprising rigid links joined to one another at biomechanical reference locations. A biomechanical reference location may also be referred to as a biomechanical joint centroid. Some biomechanical reference locations represent the position of a joint in a human skeleton, for example the position of a wrist joint, knee joint, or hip joint. Other biomechanical reference locations represent a length, width, or thickness of part of a human body, for example the length of the upper arm or the separation distance between two reference points on a spine. A biomechanical reference location may optionally represent a compound structure comprising more than one joint or more than one link. For example, a single biomechanical reference location may be assigned to represent a human hand. A biomechanical skeleton used in a model may have different articulation and possibly different connections between joints than a human skeleton.

Parameters to be supplied to an actor file are collected by recording a sequence of images from a person who follows a sequence of motions for each extremity to be captured in the actor file while maintaining close proximity to the scale frame. Following a sequence of isolated motions improves model accuracy and reduces cumulative error in the positions and angles of limbs and other body parts represented in the model. Each image to be analyzed is converted to a silhouette representing the edges of the motion capture subject's limbs, torso, head, and other parts of the subject's body. Biomechanical reference locations may be placed on each image at the ends of extremities, for example the top of a person's head or the bottom of the person's heel, at the centroid of each area determined to represent a skeletal joint on the motion capture subject, on a position selected to represent a complex structure such as a hand, or at any location on the biomechanical skeleton that may be used to represent the position of the person's body with respect to some external position reference, such as the origin of a coordinate system or the position of another object in the field of view of the camera. Embodiments may optionally be adapted to capture images and extract parameters for use in commercially available biomechanical models.

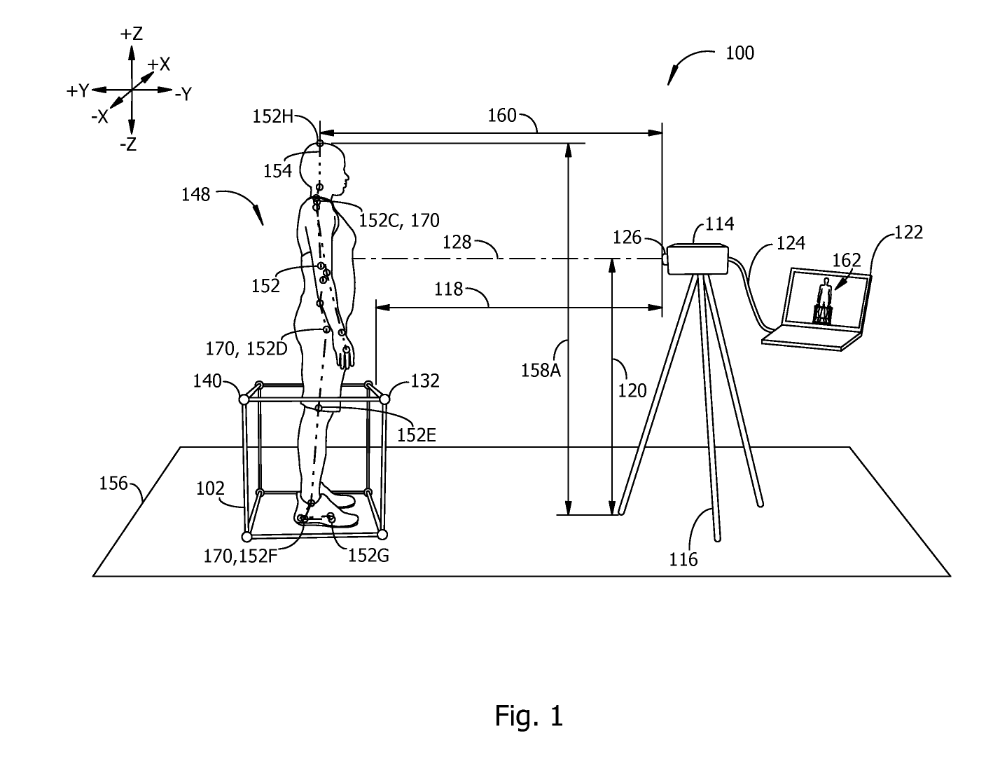

An example of an apparatus in accord with an embodiment appears in FIG. 1. The example of a motion capture system embodiment 100 is shown in an example of an arrangement of apparatus for creating a calibrated biomechanical skeleton 154 by capturing motions and positions of a person performing as a motion capture subject 148. As shown in the example of FIG. 1, an apparatus embodiment 100 includes a camera 114 and a scale frame 140 and may optionally include a computer 122 for analyzing camera images and assigning parameters for the biomechanical skeleton.

The camera 114 includes a lens 126 with an optical axis 128 positioned at a height 120 above a horizontal reference surface 156 parallel to the XY plane and tangent to the bottom side of a scale frame 102. The camera may optionally be mounted on an adjustable-height tripod 116 or similar camera support. The camera lens 126 is separated from a front side of the scale frame 102 by a separation distance 118. The optical axis in the example of FIG. 1 is horizontal, parallel to, and optionally coincident with, the Y-axis. The Z-axis in the example of FIG. 1 is vertical and perpendicular to the optical axis 128 of the camera lens. The X-axis is perpendicular to the Y and Z axes and is horizontal with respect to the floor 156, or more generally a horizontal support surface, upon which the motion capture subject 148 stands and the scale frame 102 rests. In the examples in the figures, the Y axis is oriented with (−Y) pointing toward the camera and (+Y) pointing away from the camera.

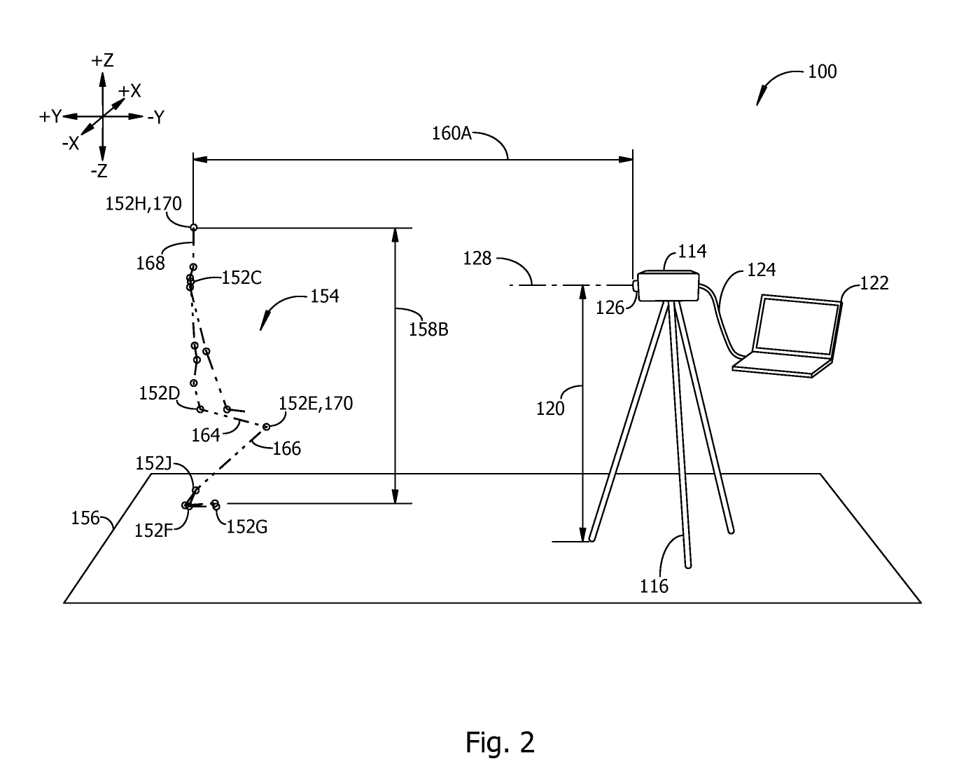

A motion capture subject 148 stands with back and legs straight inside an example of a scale frame 102 in FIG. 1, separated from the camera 114 by an example of a camera-subject distance 160. In the example of FIG. 2, the motion capture subject 148 is represented by a biomechanical skeleton 154 having a posture corresponding to a straight back and flexed knees. The camera-subject distance 160A in FIG. 2 may be different from the camera subject distance 160 in FIG. 1. Because the person's knees are flexed, the distance 158B from the floor 156 to the top 152H of the person's head is less in FIG. 2 than the corresponding distance 158A in FIG. 1.

A computer 122 receives images 162 captured by the camera 114 over a data communications connection 124. The computer, a computing device implemented in hardware, includes volatile and nonvolatile memory, a central processing unit (CPU) comprising semiconductor devices, at least one data input device such as a keyboard or mouse, and an image display, for example a liquid crystal display, a plasma display, or a light-emitting diode display. Examples of a data communication connection between the computer 122 and camera 114 include, but are not limited to, a wired connection, a wireless connection, a computer network such as a local area network, and the Internet. Alternatively, the computer 122 may receive images from the camera 114 on nonvolatile computer-readable media such as an optical disk, a magnetic disk, magnetic tape, a memory stick, a solid-state disk, or the like.

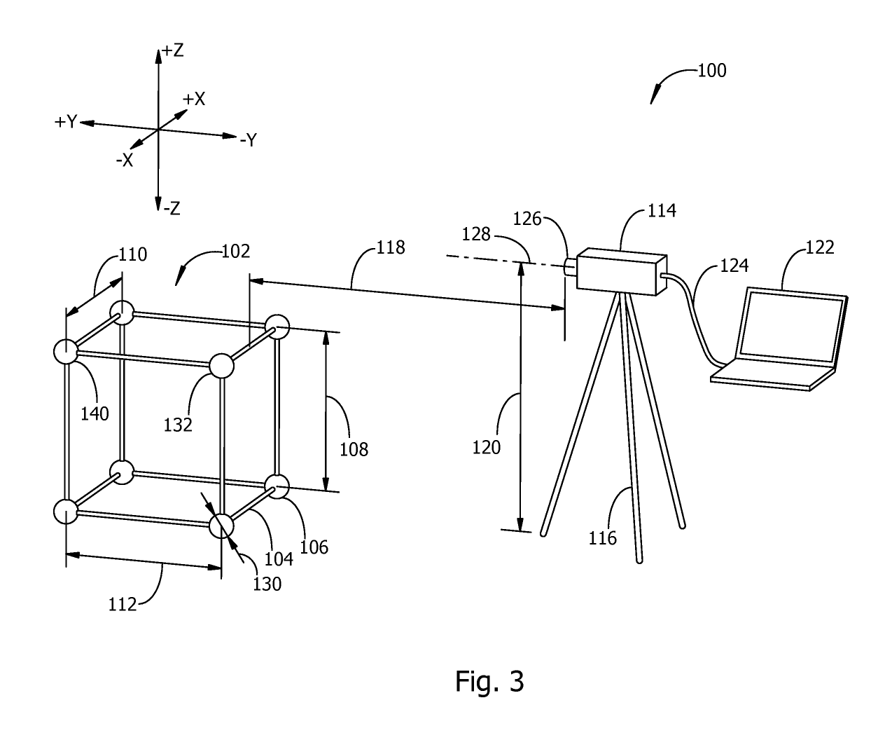

In the example of FIG. 3, the scale frame 102 includes at least four calibration markers 106 connected by struts 104. Each strut 104 is preferably perpendicular to other struts attached in common to one of the calibration markers 106. In the example of FIG. 3, a height dimension 108 (corresponding to the direction of the Z axis), a width dimension 110 (corresponding to the direction of the X axis), and a depth dimension 112 (corresponding to the direction of the Y axis) for the scale frame 102 are all equal to one another and the eight calibration markers 106 are positioned at the corners of a cube. In alternative embodiments of the scale frame 102, the length, width, and depth dimensions may differ from one another. Calibration markers 106 on different spatial axes may optionally be assigned different colors or may be marked with surface indicia such as text, numbers, or bar codes to enable post-processing software to automatically identify the directions of the x-, y-, and z-axes in a camera image and possibly to automatically remove an image of the scale frame from a captured image.

The calibration markers 106 at each corner of the scale frame may all have a same diameter 130 or may alternatively have different diameters. The diameter 106 may be selected to raise the bottom side of the scale frame sufficiently to permit a person's foot to slide under a strut 104, thereby permitting the person to position their legs and torso as close as possible to the plane of the front side of the scale frame, where the front side of the scale frame is the side closest to the camera 114 and approximately perpendicular to the optical axis 128 of the camera lens 126.

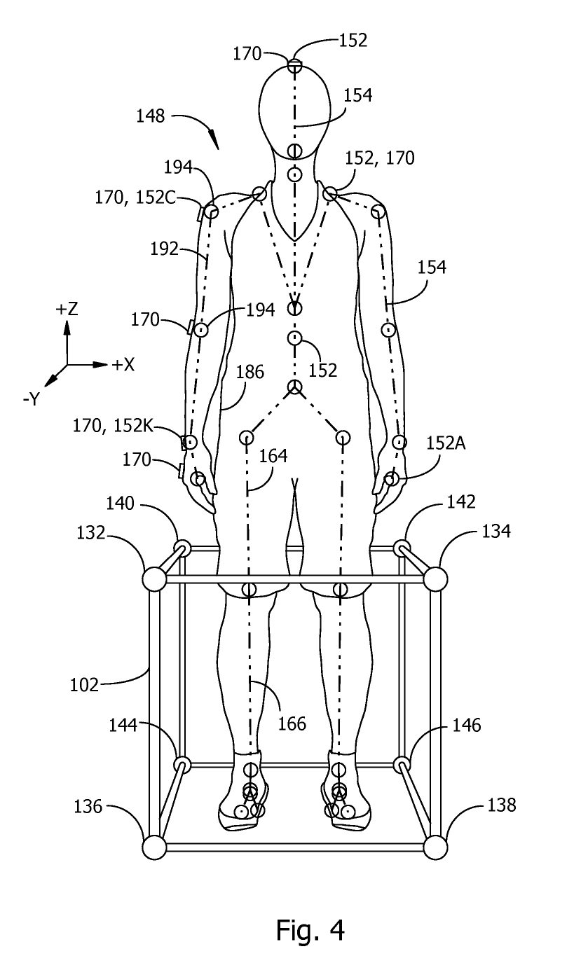

The scale frame 102 in the examples of FIGS. 3-4 comprises 12 struts and eight calibration markers, including an upper right front calibration marker 132, an upper left front calibration marker 134, a lower right front calibration marker 136, and a lower left front calibration marker 138, where left and right have been labeled with respect to the right hand (not labeled) and left hand 152A of the motion capture subject 148. Continuing on the back side of the scale frame 102, an upper right back calibration marker 140, an upper left back calibration marker 142, a lower right back calibration marker 144, and a lower left back calibration marker 146 are joined to one another and to the front calibration markers by struts. The known lengths of each strut and the known diameter of each calibration marker in the scale frame may be compared to their dimensions in a camera image of the scale frame to determine dimensions, angles, and positions for another object in the image, for example a person standing inside the scale frame. For a camera lens 126 of known focal length, the dimensions and angles of the scale frame 102 measured from an image recorded by the camera may be used to determine the separation distance 118 between the camera lens and the scale frame. Alternatively, a camera-subject distance may be determined by comparing a position measured by a motion capture sensor 170 to the position of the camera lens 126.

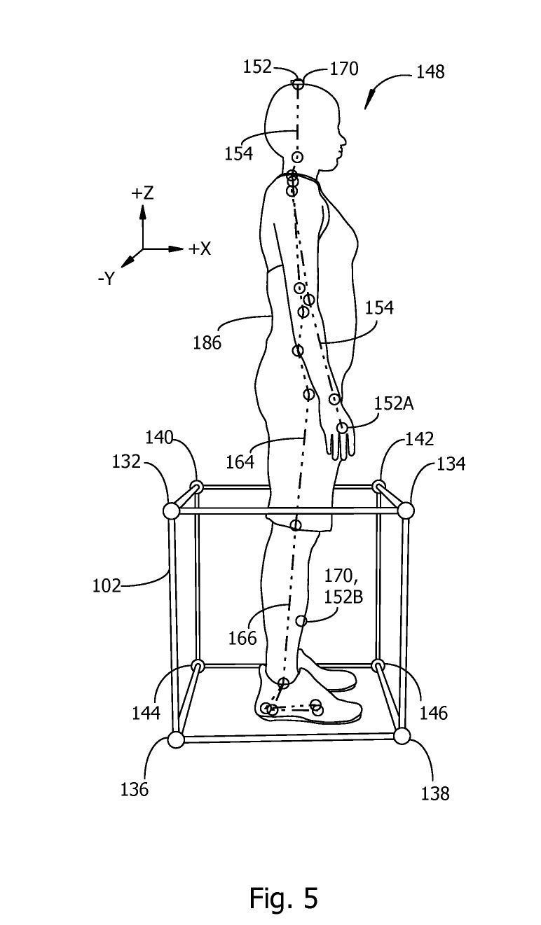

An image captured by the camera may be processed to extract parameters for an actor file. FIGS. 4-5 show different views of an example of a biomechanical skeleton 154 superimposed over an image of a motion capture subject 148 standing in a scale frame 102. The motion capture subject preferably wears a close-fitting garment 186 to improve accuracy of positions used for determining limb lengths, joint locations, and other parameters extracted from recorded images. As suggested in the example of FIG. 4, an image of a motion capture subject 148 is processed by the computer (ref. FIG. 1) to form a silhouette in the form of an outline of the head, torso, and limbs of the person 148. As the person moves, the camera collects images, for example a sequence of video images recorded at 30 frames per second. Each image is converted to a silhouette by the computer. Individual silhouette images are compared to one another by the computer to assign a location for each biomechanical reference location 152 on the biomechanical skeleton 154. A separation distance between two biomechanical reference locations 152 may define the length of a link in the biomechanical skeleton.

A biomechanical reference location 152A may represent a complex combination of links and joints. For example, reference location 152A in FIG. 5 represents a right hand. The joints and links associated with each finger in a hand may collectively be marked by one reference location 152A, or each link and joint may be modeled separately. A biomechanical reference location may optionally be assigned to represent a coordinate origin, a convenient reference representative of a position of the model in the actor file, a “root” position for the subject, that is, a reference position from which subsequent motions are made, a position of an object related to the subject 148, or other selections of convenience in forming or using an actor file. Other examples of positions for a biomechanical reference location 152 include, but are not limited to, a shoulder joint 152C, a hip joint 152D, a knee joint 152E, and ankle joint 152J, an end of a foot 152G, the top of the head 152H. A link may be positioned between pairs of related joints, for example a link 164 between the knee joint 152E and the hip joint 152D or another link 166 between the knee joint 152E and the ankle joint 152J.

A length dimension may be assigned to each link from the coordinates of the biomechanical reference locations at opposite ends of the link. A calibrated biomechanical skeleton comprises a measured coordinate position for each biomechanical reference location in the skeleton, possibly referenced to a root position for the skeleton, and may include length and orientation properties for each link and optionally a range of angular motion for each link and joint. A position may be calculated for each biomechanical reference location at an end of a segment by comparing sequential images if the motion capture subject having a different rotational position of a distal end of the segment in each of the sequential images.

An embodiment may optionally include any one or more of the following steps for calibrating a biomechanical skeleton, in which spatial directions are defined with respect to the orientation of the x-, y-, and z-axes as shown in FIGS. 1-3, the x-y plane is horizontal and parallel to the ground, and the optical axis of the camera lens is parallel to the y-axis:

positioning the camera 114 along the y-axis at a distance 118 selected to fit the motion capture subject 148 into the camera's field of view;

positioning the camera 114 at a height 120 of about half the height of the subject 148;

viewing a video image output from the camera 114 on the image display for the computer 122;

as shown in the example of FIG. 4, positioning the motion capture subject 148 in the center of the camera's field of view, facing the camera 114 in a relaxed posture and close enough to the camera to achieve desired image resolution, also referred to as an initialization pose or alternately as a master pose;

positioning the motion capture subject 148 with the right edge of the right foot in contact with the lower right front calibration marker 136 on the scale frame 102, the upper right front calibration marker 132 visible in the camera image, and the front of the subjects torso, hands, and legs as close to the plane of the front side of the scale frame as possible;

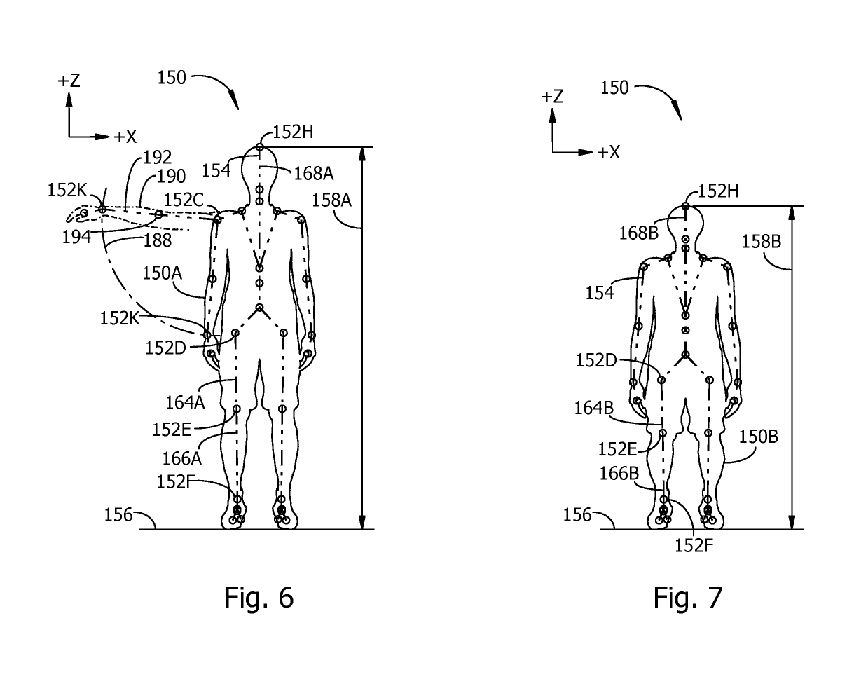

converting the image of the motion capture subject (for example image 162 in FIG. 1) to a silhouette 150 (for example silhouette 150 in FIGS. 6-7) with at least three calibration markers 106 on the scale frame 102 distinguishable from the subject's image;

overlaying an actor file, optionally an actor file compatible with a commonly used data format such as Biovision Hierarchical Data (BVH), on the silhouette;

optimizing the positioning of biomechanical reference locations on the silhouette 150;

as shown in the example of FIG. 5, rotating the motion capture subject 148 within the scale frame 102 by ninety degrees about the z-axis so the subject's side is pointed at the optical axis of the camera lens, for example the subject's right side as suggested in FIG. 3; and

repeating the step of optimizing the positioning of biomechanical reference locations;

wherein the step of optimizing further comprises any one or more of the following steps, singly or in combination, optionally performed with the right side of the torso facing the camera or alternatively with the subject in the initialization pose:

flapping hands around an axis parallel to the optical axis of the camera lens;

flapping upper arms the axis parallel to the optical axis of the camera lens;

raising arms to a horizontal position, also referred to as a “T=pose”, and raising shoulder tips (clavioscapular) along the axis parallel to the optical axis of the camera lens while keeping arms parallel to the ground;

relaxing (dropping) shoulder tips;

returning to the T-pose without using clavicles and then rotating only the elbows around an axis parallel to the optical axis of the camera lens;

returning to the initialization pose;

rotating the head and neck about a horizontal axis parallel to the optical axis of the camera lens;

rotating the rib cage about a horizontal axis parallel to the optical axis of the camera lens;

moving the torso from the waist up in rotation about a horizontal axis parallel to the optical axis of the camera lens;

putting weight on the right foot, slipping the left foot out from under the strut at the front of the scale frame by bending the left knee and straightening the left knee after the left foot has passed the lower front left calibration marker;

raising and lowering the left upper thigh in rotation about a horizontal axis parallel to the optical axis of the camera lens;

raising the left foot slightly higher than the lower front left calibration marker and rotating the ankle;

putting weight on the left foot, slipping the right foot out from under the strut at the front of the scale frame by bending the right knee and straightening the right knee after the right foot has passed behind the upper front right calibration marker;

raising and lowering the right upper thigh in rotation about a horizontal axis parallel to the optical axis of the camera lens;

raising the right foot slightly higher than the lower front right calibration marker and rotating the ankle;

raising the right upper arm with relaxed clavicle joint, stiff elbow, and stiff wrist while keeping the arm parallel to the ground and thumbs pointed up, then rotating the wrist about an axis parallel to the optical axis of the camera lens;

raising the clavicle so the scapula rotates around the a horizontal axis parallel to the optical axis of the camera lens;

keeping arms parallel to ground and pointing forward, pushing the clavicles forward and back, corresponding to rotation about the z axis;

slouching forward to rotate the ribcage around a horizontal axis parallel to the optical axis of the camera lens;

rotating the head and neck forward and back around a horizontal axis parallel to the optical axis of the camera lens;

bending from the waist forward around a horizontal axis parallel to the optical axis of the camera lens;

putting weight on the left foot, moving the right foot from under front lower strut and raising the right leg from behind, raising the leg as far as possible without moving other limbs, around the right upper leg's pelvis joint;

without bumping the scale frame, raising the right leg without bending the knee joint, toes pointed up, preferably moving the leg in rotation about an axis parallel to the optical axis of the camera lens, and preferably keeping the torso and pelvis stationary;

with elbows locked, swinging both arms in rotation about a horizontal axis parallel to the optical axis of the camera lens;

raising the right knee so the thigh is parallel to the ground and motionless, then rotating the lower leg around a horizontal axis parallel to the optical axis of the camera lens;

subtracting the radius of motion for the lower leg from the radius of motion for the entire leg;

keeping the thigh parallel to the ground with the lower leg dangling down, rotating the ankle joint around a horizontal axis parallel to the optical axis of the camera lens;

activating a warning to the subject when unwanted motions in model segments are detected;

calculating a position for each joint from a radius created by the rotation of each segment's distal end; and

after calculating a position for each joint, assigning a length for each link between adjacent joints by comparing a measured distance between joints to a known dimension on the scale frame.

Conventional optical principles permit calculation of a value for camera-subject distance for an object having a known dimension from measurements of the corresponding dimension on an image of the object and parameters of an optical system used to make the image. For example, a value for camera-subject distance (also referred to as “object distance”) may be determined from values for image distance, image height, and object height, or from angular resolution values applicable to a particular combination of image sensor pixel size, pixel counts, and lens focal length. A camera-subject distance may be calculated by comparing the height of a silhouette in a camera image to the known height of a motion capture subject standing in an initialization pose, for example a posture with the back, legs, and neck straight. However, when a motion capture subject is in a posture with flexed knees, a bent neck, or a bent torso, as may occur during running, sitting, jumping, and so on, the measured height of a silhouette in an image collected in a prior-art motion capture system may not be related to the height measured when the subject was standing straight. Occlusion of a motion capture target may prevent a prior art motion capture system from making any determination of limb and joint positions and would therefore prevent determination of camera-subject distance.

Embodiments are capable of determining a value for camera-subject distance by using the calibrated biomechanical skeleton to compensate for the posture of the motion capture subject by calculating an accurate value of object height from scaled values of link lengths in a biomechanical skeleton overlaid on a silhouette of the subject. The value of object height that applies to the particular posture of the motion capture subject may be entered into a conventional lens formula with image height measured from a silhouette and image distance determined by camera parameters to calculate camera-subject distance. A scaling ratio may be determined by dividing the measured length of a link in a biomechanical skeleton overlaid on the silhouette by the true length of the corresponding link in the calibrated biomechanical skeleton. A separate scaling ratio may apply to each link in the biomechanical skeleton overlaid on the silhouette. Measurements of the length of each link's z-axis component (i.e., the component contributing to height) in the image may be scaled and summed to give an overall dimension in the direction of the z-axis for the motion capture subject that may be used with the image height measured from the silhouette to calculate a subject-lens distance.

FIGS. 6 and 7 show examples of biomechanical skeletons used to calculate an object height that may be applied to a determination of camera-subject distance by an embodiment. In FIG. 6, a motion camera subject is represented by a silhouette 150 of person standing on the floor 156 in an initialization pose with neck, back, and legs straight. A biomechanical skeleton 154 has been mapped onto the silhouette and the positions of joints and links determined by method steps described above. A true height dimension 158A may be determined from the biomechanical skeleton in the initialization pose or by direct measurement.

FIG. 6 further illustrates an example of alternate limb positions for calibrating a biomechanical skeleton. The silhouette 150, shown in solid outline, has the subject's right arm straight along the subjects left side with the wrist joint 152K positioned below the shoulder joint 152C. An alternative position of the subject's right arm is shown in broken lines with the arm extended laterally outward from the shoulder 152C with the arm approximately horizontal. The subject may be instructed to move the arm between the two illustrated positions so that the wrist joint follows an arc 188 that lies in a plane that is parallel to the XZ plan and perpendicular to the optical axis of the camera. A position of the shoulder joint 152C for the biomechanical skeleton may be estimated by comparing the two arm positions and determining a centroid of stationary parts of the silhouette near the shoulder. More generally, the centroid of any joint, corresponding to a biomechanical joint position, may be determined by rotating parts of the body on opposite sides of the joint through an arc lying in a plane perpendicular to the optical axis of the camera lens and comparing sequential silhouette images to estimate joint position. Similarly, a length and a range of motion for each rigid link in a biomechanical skeleton can be determined by comparing corresponding biomechanical reference positions in different views of the motion capture subject, for example a view toward the front and another view toward a side of the subject.

In FIG. 7, the motion capture subject has flexed her knees and tilted her head and neck toward the camera. The motion capture subject from which the silhouette 150 is formed may be located at a different camera-subject distance in FIG. 7 than in FIG. 6. The projected lengths of an upper leg link 164B and a lower leg link 166B are shorter in the biomechanical skeleton 154 overlaid on the silhouette 150B in FIG. 7 than the upper leg link 164A and lower leg link 166A overlaid on the silhouette 150A in FIG. 6. The projected length of a link 168A from the top of the head 152H to a neck joint is longer in FIG. 6 than the projected length 168B of the same link in FIG. 7. The dimension from the floor 156 to the top of the silhouette 152H in FIG. 7 is an example of an image height 158B that may be used in camera-subject distance calculations. Scaling and summing the vertical component of each link in FIG. 7 gives the object height to be used in camera-subject distance calculations. Image distance may be determined from camera design parameters. The object distance, also referred to as camera-subject distance, may be calculated from the values for image height, object height, and image distance according to well-known optical formulae.

An alternative method embodiment includes one or more of the following steps:

capturing a first sequence of images of a motion capture subject;

for each image in the first sequence, determining a silhouette for the motion capture subject;

determining a calibrated biomechanical skeleton from the sequence of silhouettes;

capturing a second sequence of images of the motion capture subject, each image optionally at a different camera-subject distance and each image optionally representing a different posture of the motion capture subject from the preceding image; and

for each image in the second sequence of images:

forming a silhouette of the motion capture subject;

mapping an image biomechanical skeleton onto the silhouette;

determining an image height from the image biomechanical skeleton;

determining an object height from the image biomechanical skeleton and the calibrated biomechanical skeleton; and

calculating a camera-subject distance from the image height and object height for each image.

FIG. 9 may be used as an example of an ambiguity in interpreting silhouette images that may prevent accurate positioning of a biomechanical skeleton in a scene or cause a jump (discontinuity) in the position of a moving skeleton. By way of example, consider that it may be difficult to determine the actual posture of the motion capture subject from the silhouette in FIG. 9. For example, merely by examining the silhouette 150, it may be difficult to determine if the subject is facing the camera or turned with her back to the camera. Furthermore, the outlines of the flexed legs may be consistent with more than one body posture. For example, both knees could be flexed toward the camera. Or, the motion capture subject could have been standing with one leg bent with the upper leg forward (toward the camera) and the other leg bent with the upper leg trailing (away from the camera) so that one foot is ahead and the other behind the torso. The outline shape of the silhouette and projected lengths of the links in the biomechanical skeleton may not distinguish between these positions. Similarly, the left arm could be positioned ahead of the torso and right arm behind, or vice versa, and still produce the projected link lengths in the left and right arms shown in the example of FIG. 9. The tilt of the person's head offers another example of a potentially ambiguous condition in the silhouette 150. The same projected length of a link 168 in the head could be produced by tipping the head forward (closer to the camera) or backward (away from the camera). Comparing the projected lengths of links to their actual lengths derived from the calibration of the biomechanical skeleton may not resolve all positioning ambiguities.

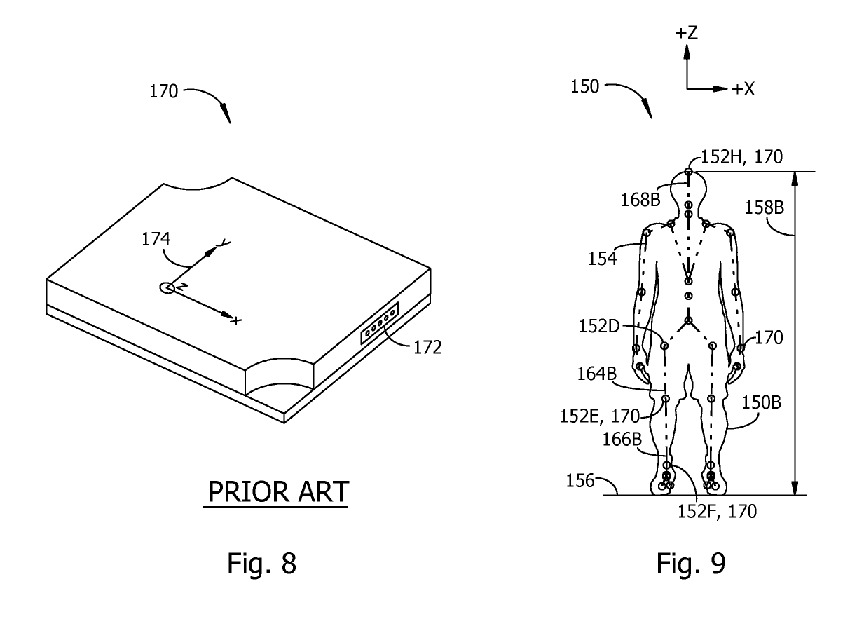

Some embodiments are capable of resolving positioning ambiguities resulting from similar link projections for different body postures by comparing biomechanical reference locations 152 to measurements from at least one motion capture sensor worn by a motion capture subject. An example of a motion capture sensor 170 in accord with an embodiment is shown in the prior art illustration of FIG. 8. The motion capture sensor 170 may include an electrical connector 172 for making electrical connections to other sensors or to a data acquisition system, and may include direction references 174 or similar indicia to indicate the directions of the spatial axes used by the sensor for reporting directions and possibly rotational angles of motions. Examples of motion capture sensors suitable for use with an embodiment include, but are not limited to, inertial measurement sensors, tilt sensors, angle sensors, accelerometers, and articulated motion capture linkages worn by a motion capture subject. Examples of an articulated motion capture link suitable for use with an embodiment appear in Motion capture sensors may be attached to an elastic band or an article of clothing, for example a garment 186 (ref. FIG. 5), a hat or cap, pair of gloves, pair of shoes, and so on. The example of a motion capture sensor 170 in FIG. 8 is approximately 1 cm square by about 3 mm thick, although sensors of other sizes may be used.

Motion capture sensors may be worn by a motion capture subject at positions corresponding to biomechanical reference locations. For example, a motion capture sensor 170 is shown at the biomechanical reference location 152H in FIG. 9. Another sensor 170 is shown at the right knee joint 152E. A motion capture sensor may be placed at any position on a motion capture subject, for example a position a known separation distance from a joint as shown at reference location 152B in FIG. 5. Compared to prior art systems which may use sensors to measure a position of each joint and link to be captured in a model, embodiments may include only those sensors which assist in resolving positioning ambiguities resulting from similar projected link lengths. For example, a single sensor on each leg enables an embodiment to correctly assign positions for the upper and lower biomechanical skeleton links on both legs. A single sensor on each arm resolves which arm is forward and which is back when the link lengths are ambiguous. One sensor on the head resolves whether the head is tipped forward or back, and so on. Sensors are not needed to determine limb lengths. Having at least one sensor on a motion capture subject permits an accurate determination of camera-subject distance. Embodiments need fewer sensors than prior art systems to accurately position a biomechanical skeleton in a scene.

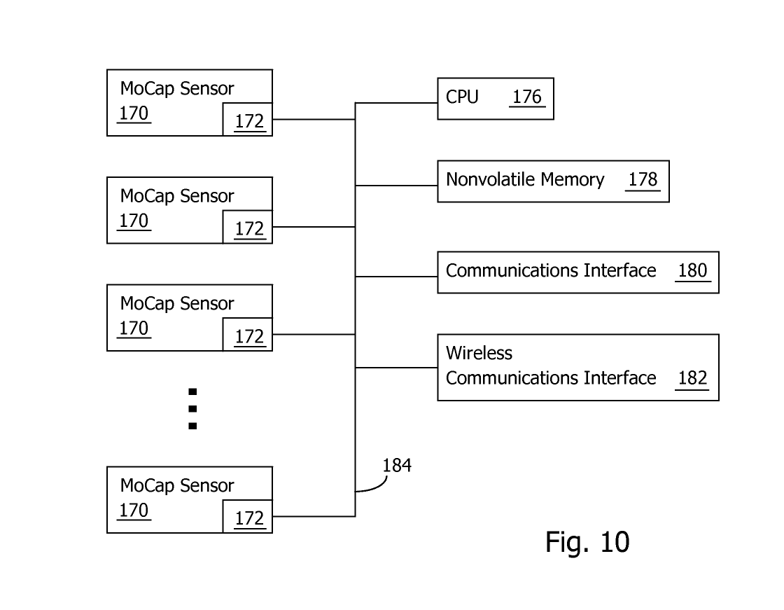

FIG. 10 shows a simplified block diagram of an example of a circuit for reading position information from motion capture (mocap) sensors attached to a motion capture subject. Each of a plurality of mocap sensors 170 worn by a motion capture subject is coupled by an electrical connector 172 to a CPU 176 by electrical connections 184. Examples of a CPU 176 include, but are not limited to, hardware implementations of a microcontroller, a microprocessor, an application specific integrated circuit (ASIC), a gate array, and a programmable logic device (PLD). The CPU is in data communication with a nonvolatile memory 176, an optional wired communications interface 180, for example a network interface, a parallel interface, or a serial interface, and possibly with an optional wireless communications interface 182, for example a WiFi interface or a Bluetooth interface. The CPU, nonvolatile memory, and communication interface circuits may optionally be worn by a motion capture subject or may alternatively be separated from the mocap sensors worn by the subject and connected to the sensors when sensor data is to be read and stored for use in motion capture. The CPU 176 may optionally be the same CPU used to perform any one or more of the steps of creating silhouettes, performing calibration of a biomechanical skeleton, superimposing the biomechanical skeleton on a captured image from a camera, and moving the biomechanical skeleton to coincide with position data measured by one or more motion capture sensors.

Unless expressly stated otherwise herein, ordinary terms have their corresponding ordinary meanings within the respective contexts of their presentations, and ordinary terms of art have their corresponding regular meanings.

What is claimed is:

1. An apparatus, comprising:
a scale frame, comprising at least three struts and at least four calibration markers, wherein one of each of said at least four calibration markers is attached to an end of each of said at least three struts and said at least three struts are joined at right angles to one another by one of said at least three calibration markers;
a camera;
a computer implemented in hardware, wherein said computer is in data communication with said camera and said computer is adapted to receive an image from said camera, convert said image to a silhouette, and extract parameters for a biomechanical skeleton from said image; and
a motion capture sensor in data communication with said computer.

2. A method, comprising:
positioning a camera facing a scale frame with an optical axis for a lens on the camera horizontal and directed at a front side of the scale frame;
positioning a motion capture subject inside the scale frame;
recording at least two images, each image including the motion capture subject and the scale frame;
converting a first image of the motion capture subject to a first silhouette image;
converting a second image of the motion capture subject to a second silhouette image;
assigning a first biomechanical reference location for a biomechanical skeleton from a comparison of the first silhouette image to the second silhouette image;
assigning a second biomechanical reference location for the biomechanical skeleton from a comparison of the silhouette image to the second silhouette image;
connecting a link in the biomechanical skeleton between the first and second biomechanical reference locations;
assigning the projected length of the link from the positions of the first and second biomechanical reference locations measured from the first and second images of the motion capture subject;
measuring the projected length of a selected strut on the scale frame in the first and second images;
determining a true length of the link from the projected length of the link and the projected length of the strut in the first image and the projected length of the strut in the second image; and
assigning the true length of the link to the biomechanical skeleton.

3. The method of claim 2, further comprising determining a true length for an other link in the biomechanical skeleton from a projected length measured from the first image and the second image.

4. The method of claim 3, further comprising the motion capture subject flapping hands around an axis parallel to the optical axis of the camera lens.

5. The method of claim 3, further comprising:
the motion capture subject rotating an arm about an axis parallel to the optical axis of the camera lens;
raising the arm to a horizontal position;
raising a shoulder while keeping the arms horizontal; and
lowering the shoulder to a rest position.

6. The method of claim 3, further comprising rotating the arm at an elbow joint around an axis parallel to the optical axis of the camera lens.

7. The method of claim 3, further comprising the motion capture subject performing a rotation of the head and neck about a horizontal axis parallel to the optical axis of the camera lens.

8. The method of claim 3, further comprising the motion capture subject performing a rotation of the torso about a horizontal axis parallel to the optical axis of the camera lens.

9. The method of claim 3, further comprising the motion capture subject performing a movement of the torso from the waist up, the movement a rotation about a horizontal axis parallel to the optical axis of the camera lens.

10. The method of claim 3, further comprising the motion capture subject putting weight on a right foot, slipping a left foot from under the scale frame by bending a left knee, and straightening the left knee after the left foot has passed the lower front left calibration marker.

11. The method of claim 3, further comprising:
the motion capture subject raising and lowering a left upper thigh in rotation about a horizontal axis parallel to the optical axis of the camera lens;
raising a left foot slightly and rotating an ankle;
putting weight on the left foot, slipping a right foot from under the scale frame by bending a right knee and straightening the right knee after the right foot has passed behind an upper calibration marker on the scale frame;
raising and lowering an right upper thigh in rotation about a horizontal axis parallel to the optical axis of the camera lens; and
raising the right foot slightly higher than a lower front calibration marker on the scale frame and rotating a left ankle.

12. The method of claim 3, further comprising:
the motion capture subject raising an right arm and an elbow and a wrist on the right arm held stiff while keeping the right arm horizontal and a thumb on a right hand pointed upward; then rotating the wrist about an axis parallel to the optical axis of the camera lens; and
positioning the right arm and a left arm parallel to one another and pointing toward the camera, rotating both shoulders toward and away from the camera, and pushing the clavicles toward and then away from the camera.

13. The method of claim 3, further comprising the motion capture subject bending at the waist forward toward the camera lens.

14. The method of claim 3, further comprising the motion capture subject putting weight on a left foot, moving a right foot from under a front lower strut of the scale frame, and raising the right leg in rotation about a joint between the right leg and pelvis.

15. The method of claim 14, further comprising the motion capture subject raising the right leg without bending a right knee joint, and toes on a right foot pointed up, moving the right leg in rotation about an axis parallel to the optical axis of the camera lens, and with a stationary torso and a stationary pelvis.

16. The method of claim 3, further comprising the motion capture subject rotating both arms with elbows locked.

17. The method of claim 3, further comprising the motion capture subject raising a right knee until a right thigh is horizontal, then rotating the right leg below the knee around a horizontal axis parallel to the optical axis of the camera lens.

18. The method of claim 3, further comprising the motion capture subject positioning a thigh horizontally with a distal end of a leg positioned vertically and rotating an ankle joint about a horizontal axis parallel to the optical axis of the camera lens.

19. The method of claim 2, further comprising warning the motion capture subject when unwanted motions in model segments are detected;.

20. The method of claim 2, further comprising calculating a position for a biomechanical reference location at an end of a segment by comparing sequential images if the motion capture subject having a different rotational position of a distal end of the segment in each of the sequential images.
